(19) United States
(12) Patent Application Publication
(10) Pub. No.: US 2017/0371654 A1
(43) Pub. Date: Dec. 28, 2017

(54) SYSTEM AND METHOD FOR USING VIRTUAL VECTOR REGISTER FILES

(71) Applicants: Advanced Micro Devices, Inc., Sunnyvale, CA (US); ATI Technologies ULC, Markham (CA)

(72) Inventors: Ljubisa Bajic, Toronto (CA); Michael Mantor, Orlando, FL (US); Syed Zohaib M. Gilani, Markham (CA); Rajabali M. Koduri, Sunnyvale, CA (US)

(73) Assignees: Advanced Micro Devices, Inc., Sunnyvale, CA (US); ATI Technologies ULC, Markham (CA)

(21) Appl. No.: 15/191,339

(22) Filed: Jun. 23, 2016

(51) Int. Cl. G06F 9/30; G06F 12/0891

(52) U.S. Cl. CPC G06F 9/3012; G06F 12/0891; G06F 9/3001; G06F 9/30036; G06F 2212/604

(57) ABSTRACT

Described is a system and method for using virtual vector register files. In particular, a graphics processor includes a logic unit, a virtual vector register file coupled to the logic unit, a vector register backing store coupled to the virtual vector register file, and a virtual vector register file controller coupled to the virtual vector register file. The virtual vector register file includes a N deep vector register file and a M deep vector register file, where N is less than M. The virtual vector register file controller performing eviction and allocation between the N deep vector register file, the M deep vector register file and the vector register backing store dependent on at least access requests for certain vector registers.

### BACKGROUND

Graphics processing units (GPUs) are parallel processors with large numbers of execution units and high-bandwidth memory channels to concurrently run thousands of threads. The GPU architectures are centered around large arrays of single-instruction multiple thread (SIMT) units, each an in-order, score board based, super scalar machine with a full set of functionality—an instruction fetch and scheduling pipeline, a vector arithmetic logic unit (ALU) including hardware support for transcendental functions, memory subsystem, and a vector register file. Vector register files have emerged as a major bottleneck in modern GPU architectures as they present a considerable challenge to all aspects of GPU operations—including cost, area, power and timing.

### BRIEF DESCRIPTION OF THE DRAWINGS

A more detailed understanding may be had from the following description, given by way of example in conjunction with the accompanying drawings wherein:

FIG. 1 is a high level block diagram of a graphics processor in accordance with certain implementations;

FIG. 2 is a high level block diagram of a graphics processing pipeline in accordance with certain implementations;

FIG. 3 is a logical block diagram of a graphics processor with a vector register file in accordance with certain implementations;

FIG. 4 is an example flow for a single-instruction multiple-thread (SIMT) unit in accordance with certain implementations;

FIG. 5 is a logical block diagram of a virtual vector register file in accordance with certain implementations;

FIG. 6 is a logical block diagram of a virtual vector register file controller for use with a virtual vector register file in accordance with certain implementations;

FIG. 7 is a logical block diagram with operational flow for a virtual vector register file in accordance with certain implementations;

FIG. 8 is a flowchart for using a virtual vector register file in accordance with certain implementations; and

FIG. 9 is a block diagram of an example device in which one or more disclosed implementations may be implemented.

### DETAILED DESCRIPTION

Described is a system and method for using virtual vector register files. In particular, a graphics processor includes a logic unit, a virtual vector register file coupled to the logic unit, a vector register backing store coupled to the virtual vector register file, and a virtual vector register file controller coupled to the virtual vector register file. The virtual vector register file includes a N deep vector register file and a M deep vector register file, where N is less than M. The virtual vector register file controller performs eviction and allocation between the N deep vector register file, the M deep vector register file and the vector register backing store depending upon at least access requests for certain vector registers.

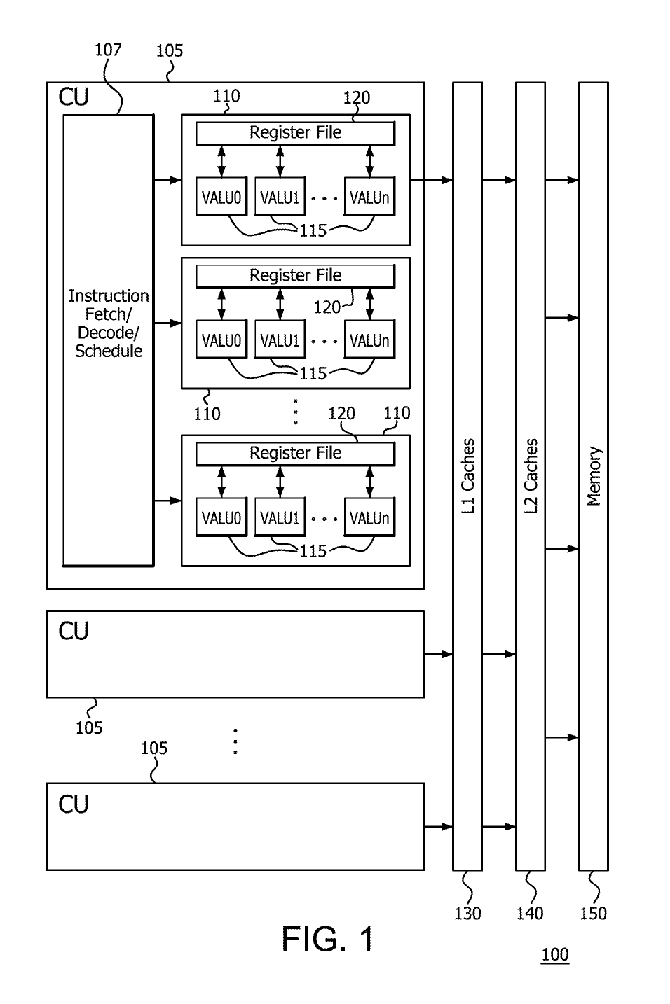

FIG. 1 is a high level block diagram of a shader compute part in a graphics processor or GPU 100. The shader compute part of the graphics processor 100 includes compute units 105, where each compute unit 105 included a sequencer 107 and multiple single instruction, multiple thread (SIMTs) units 110. Each SIMT unit 110 can include multiple VALUs 115, where each VALU 115 can be connected to a vector register file 120. Each compute unit 105 is connected to an L1 cache 130, which in turn is connected to an L2 cache 140. The L2 cache 140 can be connected to memory 150. For example, in a Graphics Core Next (GCN) architecture, each compute unit 105 can include 4 SIMT units, each SIMT unit can include 4 VALUs and each VALU can include 4 ALUs. Although the description herein is with respect to an example architecture, different levels of multi-threading per SIMT, different number of operands per SIMT and different hardware widths can be implemented without departing from the scope of the claims. The description herein is illustrative.

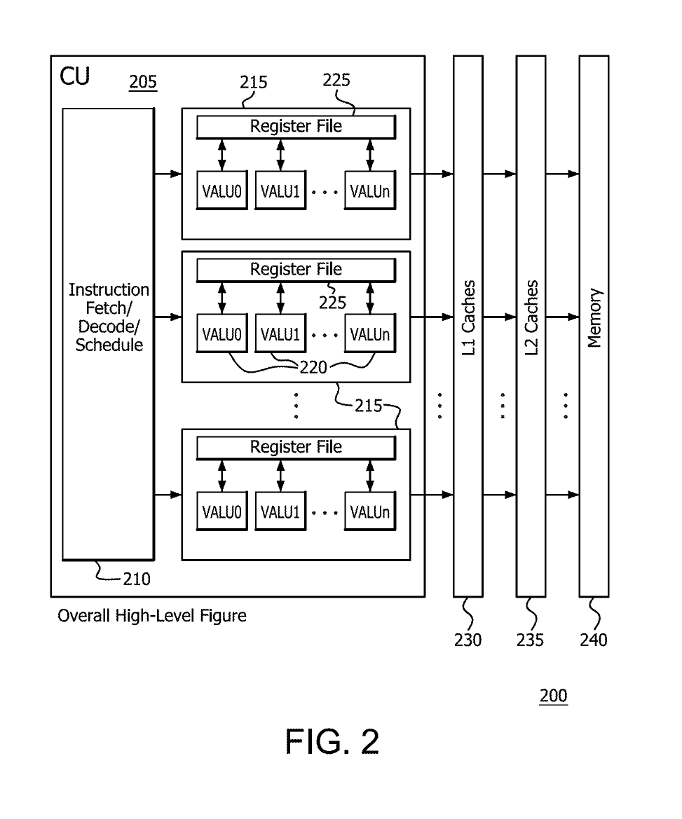

FIG. 2 is a high level block diagram of a graphics processor pipeline 200 that transforms a three-dimensional scene onto a two-dimensional screen. The graphics shader compute processing pipeline 200 initially performs an instruction fetch, decode and schedule process by a sequencer 210 in a compute unit 205. The instruction and data is then fed to execution units in a compute unit 210. The execution units can include 4 SIMTs 215, where each SIMT 215 in turn can include 4 VALUs 220. Each VALU 220 can be a group of 4 ALUs. The output of the compute unit 205 can be stored in a vector register file 225, a L1 cache 230, a L2 cache 235 or a memory 240.

In general, graphics processing units (GPUs) are parallel processors with large numbers of execution units and high-bandwidth memory channels to concurrently run thousands of threads. The GPU architectures are centered around large arrays of SIMT units, each an in-order, score board based, super scalar machine with a full set of functionality—an instruction fetch and scheduling pipeline, VALUs including hardware support for transcendental functions, memory subsystems, and vector register files. Vector register files have emerged as a major bottleneck in modern GPU architectures as they present a considerable challenge to all aspects of GPU operations—cost, area, power and timing.

Each SIMT unit 215 can implement extensive fine grained multi-threading in hardware and therefore can require a large number of vector registers per vector register file to maintain run time context for all threads concurrently executing in the SIMT unit. Consequently, SIMT units 215 in many GPUs generally implement large vector register files. As the SIMT units 215 are, in essence, vector machines, the register files need to provide read access for three vector operands and write access for one vector operand in every machine clock cycle. Additional read and write ports can also be required to handle shared memory or GPU memory reads and writes. Some GPUs achieve the required high bandwidth and keep cost under control by implementing vector register files as multiple banks of pseudo-dual ported static random access memory (SRAM). Shader compilers perform judicious instruction ordering in order to minimize the likelihood of bank conflicts triggered by the generated code.

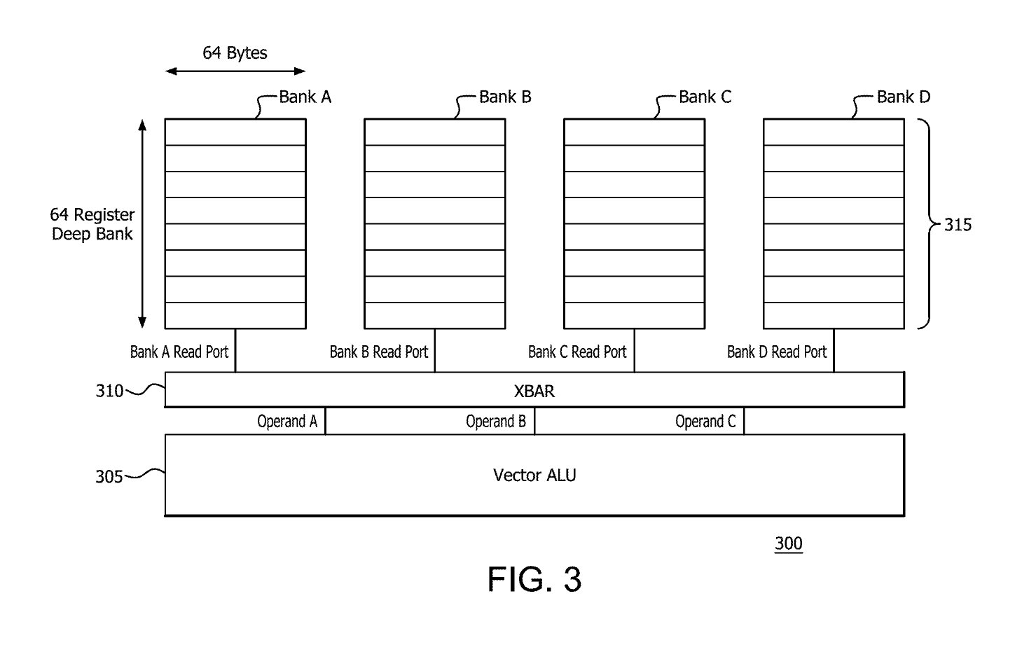

FIG. 3 is a logical block diagram of a graphics processor or GPU 300 including a VALU 305. As noted above, the VALU 305 can have 4 ALUs (not shown). The VALU 305 is connected or coupled to multiple banks of vector register files 315, for example, Bank A, Bank B, Bank C and Bank D, via a crossbar switch (XBAR) 310. The XBAR 310 can receive source (read) operands from the vector register file banks and write (destination) operands from VALU 305. The XBAR 305 can have a plurality of ports for read and write operations including for example, Bank A Read Port, Bank B Read Port, Bank C Read Port, and Bank D Read Port that connect the XBAR 310 to Bank A, Bank B, Bank C and Bank D, respectively.

Vector register files 315 have emerged as a major bottleneck in modern GPU architectures as the vector register files present a considerable challenge to all aspects of GPU operation—cost, area, power and timing. In terms of area and cost, the SIMT vector register files are a large contributor to most GPU's area, constituting about 10% of the area. Reducing vector register file area translates to significant reduction of GPU area. In addition to the direct area considerations, vector register file area constrains a number of optimizations for power and performance that would otherwise be trivial and fruitful. An optimization, for example, includes further RAM banking for power reduction, (i.e. segment RAM into several pieces and only put the one being accessed in an operational state, leaving others in low power states). Even just doubling the number of SRAM banks increases area by 25%-30%. Another optimization, for example, includes running the SRAM at a higher frequency. Current vector register file SRAMs are implemented as pseudo-dual ported, (i.e. a single set of word lines is used for both ports), which severely limits the top frequency that the SRAMs can achieve. Moving to a truly dual ported design, with separate word lines for the two ports, may yield a desirable increase in maximum SRAM operating frequency or, in general, may enable achieving the same frequency at lower voltage but would again cause an increase in area and power. From this perspective, decreasing vector register file area would enable other optimizations to performance and/or power while maintaining area neutrality with respect to existing designs.

In terms of power, in addition to being the largest single contributor to area, SIMT vector register files are a large contributor to GPU active power, accounting for 10-15% of the GPU power. A reduction of power consumed in the vector register files is thus desired. Considerable reduction in vector register file power may be trivially achieved by further banking. However, as described above, this action may result in significant area penalty.

In terms of timing, SIMT vector register files are implemented using low cost SRAM configuration that achieves required read and write bandwidth. However, these SRAMs may not be particularly fast and thus present a limit on frequency, (or minimum operating voltage), achieved by the SIMT design. Implementing the vector register files using faster, true dual port, SRAM results in a large area increase.

As shown in the example, illustrative architecture of FIGS. 1-3, graphic processors 100 can center around an array of 64 operand wide SIMT units 110 (or SIMT 215 in FIG. 2), where each SIMT unit 110 can implement support for ten-way simultaneous multi-threading, (with each thread being SIMT, 64 operands wide, in turn). Despite the fact that each SIMT unit 110 is logically 64 operands wide, in hardware they are implemented as 16-wide, with a single SIMT instruction taking 4 clock cycles to issue and execute. The vector register file in each SIMT unit 110 is 16 single precision floating point operands wide.

The SIMT units 110 rely on the fact that they have support for several resident threads, (each thread being 64 operands wide), to hide long latencies associated with memory access in any given thread. For example, when the currently running SIMT thread encounters a dependency on a vector register file that is awaiting return of data from memory, it is suspended and a new thread is activated; the original thread is re-activated when the dependency that stalled it is resolved, (upon data returning from memory and filling the mentioned vector register, for example). This mechanism is identical regardless of whether the awaited memory data is coming from dynamic RAM (DRAM), a cache, or the local scratchpad memory.

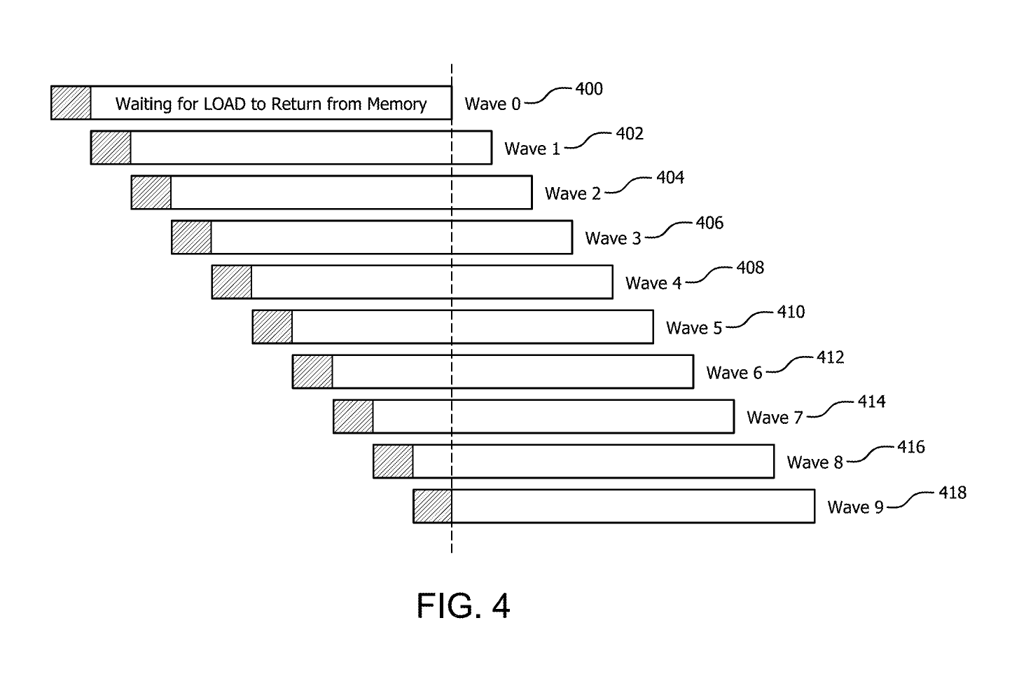

Keeping an SIMT engine's ALU constantly occupied is a pre-requisite for efficient operation and comes down to ensuring that at any given moment there is always ready, non-stalled, code available to dispatch to the ALUs. A situation where all 10 supported threads are stalled and waiting for a dependency to resolve yields idle cycles on the SIMT engine and inefficient operation. FIG. 4 shows an example scenario where 10 threads 400, 402 . . . 418 are running on a SIMT unit in a configuration that barely saturates the SIMT unit. If one of the threads 400, 402 . . . 418 saw a reduction of its compute/memory operation ratio, the SIMT unit would start having idle clock cycles and thus go below 100% efficiency. There are multiple methods for reducing execution stalls due to pending data returns from memory, e.g. data prefetching. However, these optimization methods often result in greater vector register file usage.

Register file usage in graphics processors may also be tweaked to improve performance. For example, when a piece of shader code is compiled, the compiler determines an appropriate number of registers needed for the code. The compiler generally uses a user-specified configuration that sets a maximum number of vector register files to use. However, the compiler is free to allocate vector register files in accordance with its optimization algorithms. If the original shader code truly requires more vector register files than the compiler is limited to use, code that performs vector register file spill and fill to and from memory is automatically added by the compiler. Spilling to memory lowers performance and high performance code generally avoids usage of vector register file spill and fill.

Before a compiled shader can execute on the graphics processor, one or more SIMT units first have to allocate resources for it. A hardware thread scheduling block, (for example, a Shader Pipe Interpolator (SPI)), performs resource bound checking as part of its scheduling work to assign the shader code to SIMT units that have sufficient resources available for it. As a result of this activity, it is ensured that all threads dispatched to any given SIMT unit do not use more vector registers than are available in the SIMT unit. The hardware resources of the SIMT unit that are used by a thread are dedicated to the same thread until it has completed execution of all of its instructions. A side effect of this hardware scheduling is that, in general, some vector registers in a SIMT unit are unused. As an example, if the SPI is scheduling 10 identical threads, and each one of them requires 100 vector registers, it will only be able to schedule 2 threads at a time to work on any SIMT unit. The two threads will utilize 200 vector registers and 56 will go unused, (assuming a vector register file with 256 registers, for example). The exact number of unused vector registers depends on the mix of code running in the graphics processor, but in either case this behavior constitutes a definite opportunity for register file optimization.

In another example, at any given time, a large amount of vector registers, (all vector registers that are used for staging for data coming from a higher level in the memory hierarchy), are serving as the target of LOAD instructions. The values held in those vector registers are out of date, and the vector register storage itself is useless except as reserved storage for data returns. This is another opportunity for optimization.

In another example, modern game development engines often utilize “super pixel shaders” which implement a super set of functionality that is intended to cover many potential use cases, with multitudes of materials and associated bidirectional reflectance distribution function (BRDFs) as well as multitudes of different light sources with different properties. This trend in shader development results in a number of variables that the shader compiler has to allocate to vector registers. This vector register allocation may be unnecessary since the vector registers may not be used at all, (or used very sparingly). This occurs because the decisions of which material/light/other characteristic is actually being used in a given shader invocation are done dynamically using branching at run time. This is another opportunity for optimization.

In general, persistent traits are visible across all graphics processor work-loads, graphics rendering and compute scenarios for register usage. These traits may include that a vector register value is most often (˜60% of time) accessed only one time. That is, an ALU or LOAD results in only read a single time before being over-written or not being referenced any more. Other traits may be that a vector register value is accessed one or two times in 90% of cases or that 70% of vector register values that are read only once are not consumed immediately. In case a register value is accessed more than once, the average time between consecutive accesses is >400 GPU clock cycles, and for many workloads it is >1000 clock cycles.

Described is a system and method for using virtual vector register files that may address all of the bottlenecks presented by current register file architecture by yielding lower die area, lower power and faster SIMT units while balancing low latency and register usage. The virtual vector register file architecture can include a two level, non-homogenous hardware vector register file structure that can yield considerable power benefits by avoiding the access of large structures in favor of small structures whenever possible. Management of vector register allocation between the two levels is provided in order to minimize the number of accesses to a larger vector register file. In particular, the virtual vector register file architecture provides more efficient management of vector register file storage by avoid having a large percentage of vector registers that are unusable at any given time and reducing vector register file size. For example, for the “super pixel shaders,” the virtual vector register file neatly avoids spending costly physical vector register storage on unused (or used once twice—then dead) vector registers.

In general, the virtualized vector register file structure provides the same logical view to software and SPI, (256 virtual vector registers), but implements only a subset of the 256 virtual vector registers in the chip, for example 128 or 196. In order to maintain the full logical view of 256 available vector registers to the software and SPI, vector registers need to support being swapped in and out of a backing store in memory.

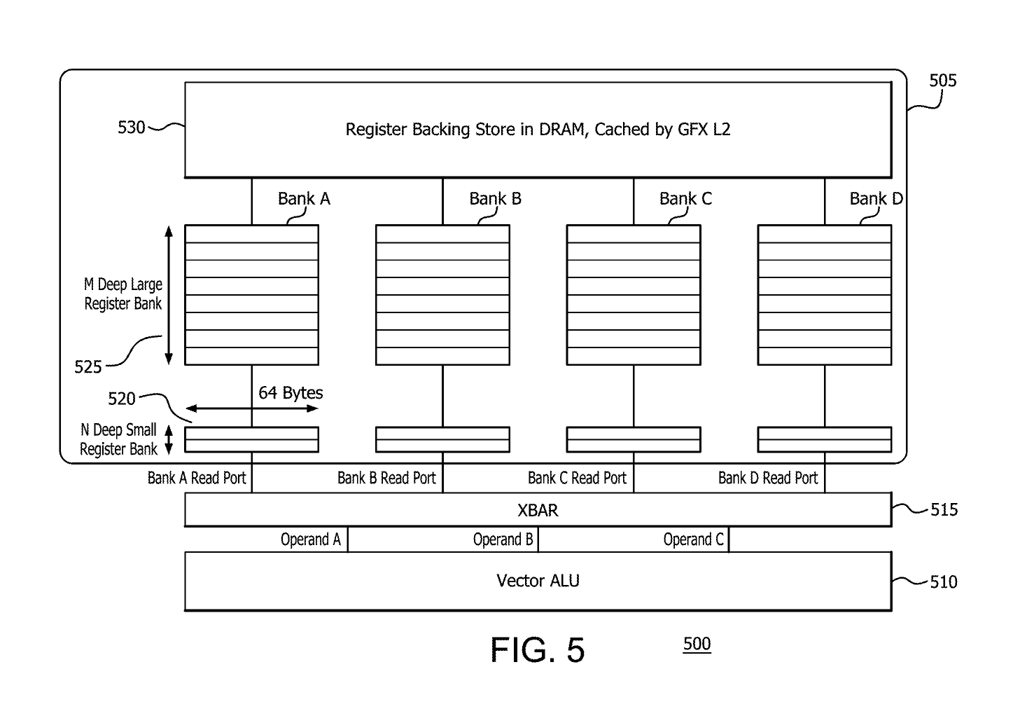

FIG. 5 is a logical block diagram of a portion of a graphics processor 500 with a virtual vector register file 505. The graphics processor 500 includes a VALU 510 that is connected or coupled to the virtual vector register file 505 via a crossbar switch (XBAR) 515. In particular, the XBAR 515 receives operands from the VALU 510. The virtual vector register file 505 can have multiple banks of vector registers, for example, Bank A, Bank B, Bank C and Bank D. Each bank of vector registers can include a small, low power vector register file 520 and a larger, power hungry vector register file 525. Both vector register files are equally wide. The vector register file 520 can be N vector registers deep and the vector register file 525 can by M vector registers deep, where M is greater than N. The XBAR 310 has a plurality of ports for read and write operations including for example, Bank A Read Port, Bank B Read Port, Bank C Read Port, and Bank D Read Port that connect the XBAR 310 to each bank of vector register file 520. The vector register file 525 is be connected to a vector register backing store 530 that can be implemented in a memory, such as a DRAM.

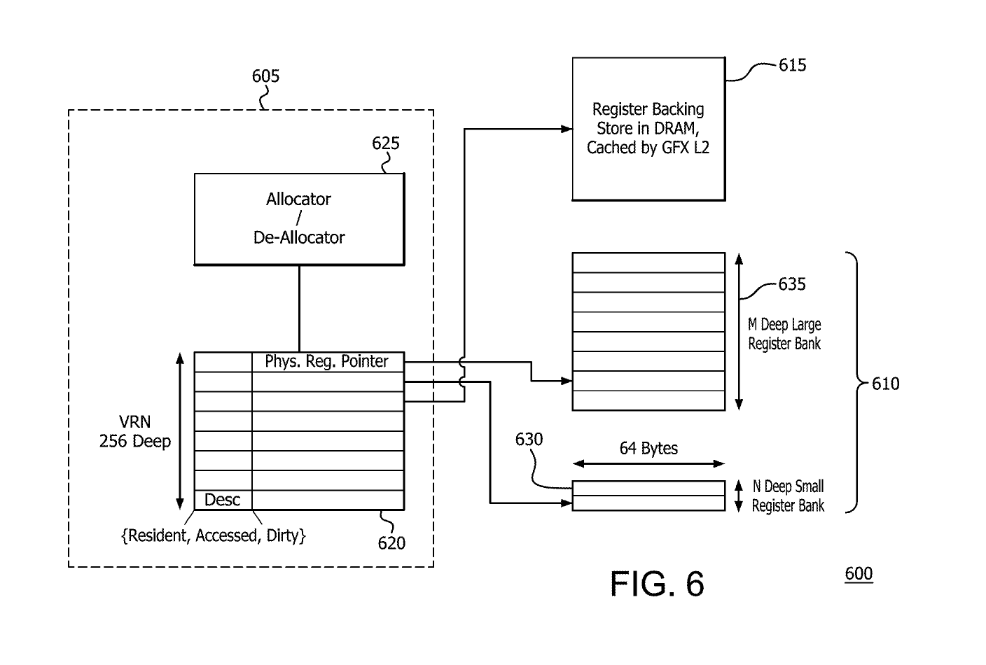

FIG. 6 is a logical block diagram of a portion of a graphics processor 600 including a virtual vector register file controller 605 for use with a virtual vector register file 610 and a register backing store 615. The virtual vector register file controller 605 facilitates the virtualization functionality and the two level vector register file. In particular, the virtual vector register file controller 605 provides the same logical view to the software and the SPI as if all of the vector register files were physically implemented. The virtual vector register file controller 605 includes a vector register re-mapping table 620 connected to an allocator/de-allocator module 625. The virtual vector register file 610 includes a small vector register file 630 with N vector registers and a large vector register file 635 with M vector registers.

The vector register re-mapping table 620 is indexed by a virtual vector register number with each table entry storing a pointer to a corresponding physical hardware vector register file, (such as the small vector register file 630 or the large vector register file 635), or the vector register backing store 615. Each table entry can also contain a “resident” bit that signifies whether a vector register is present in the physical hardware vector register file, (as opposed to being in the vector register backing store), an “accessed” bit to enable usage of replacement algorithms for vector register allocation/de-allocation, and a “dirty” bit that can be used to optimize write-back to the next higher level of vector register file hierarchy. The CLOCK algorithm can be an example of a replacement algorithm.

In addition to supporting vector register file virtualization, the vector register re-mapping table 620 along with the allocator/de-allocator module 625 can be used for managing vector register assignments across the small vector register file 630 and the large vector register file 635. In particular, definition of an efficient vector register allocation/de-allocation scheme drives efficiency of the virtual vector register file architecture. Physical register allocation is driven by demand, (an instruction needs a vector register that is in the backing store, a load result has returned from memory, and the like), decisions on whether to allocate a physical vector register in the small or large vector register file and determinations on which vector register already resident in the vector register file to evict, all of which are expected to be based on a combination of factors or heuristics.

Consistent patterns observed in the vector register usage of GPUs enable the use of some simple heuristics to optimize vector register management. An example heuristic can be return data from a load or texture access instruction that gets allocated in the small vector register file 630 as it is likely to be accessed soon. In another example, a virtual vector register that is attempted to be accessed by an instruction yet is currently not resident on chip, (i.e., it is in the vector register backing store 615), gets allocated and brought into the small vector register file 630 since it is likely to be read soon. The vector register file location for the incoming virtual vector register is not allocated until the relevant value arrives from memory, (i.e. a just-in-time allocation), as opposed to pre-allocating upon vector register initiation. In another example, a virtual vector register that holds the value for a STORE instruction can be transferred from the small vector register file 630 to the large vector register file 635 or the vector register backing store 615 since that value may not be used soon. In contrast, an ALU instruction result can get stored in the small vector register file 630 as it is likely to be accessed again soon. The above heuristics are illustrative for vector register file allocation and de-allocation and others can be used without deviating from the scope of the description.

The virtual vector register file controller 605 maintains a set of lists, (or data structures), for vector register file management. That is, these files can be hardware managed lists. For example, a hardware virtual vector register file controller can maintain different lists to move vector registers to different vector register files or to a backing store. Each list can contain the best candidate vector registers to be moved to the other vector register files or backing store. One set of lists can be maintained for eviction processing and can include: 1) Good candidates for eviction to large vector register file (EVS2LARGE), where a vector register that is resident in the small vector register file, and is accessed by either an ALU or STORE instruction, is added to the EVS2LARGE list; and 2) Good candidates for eviction to backing store (EVS2BSTR and EVL2BSTR), where a vector register that is the target of a LOAD instruction that does not exhibit any branch divergence (all threads execute it) is added to the EVS2BSTR or EVL2BSTR depending on whether the vector register is resident in the small or large hardware vector register file.

Another set of lists can be maintained for allocation and de-allocation processing and can include: 1) FREESMALL, which maintains a list of physical vector registers in the small vector register file that are currently unallocated; and 2) FREELARGE, which maintains a list of physical vector registers in the large vector register file that are currently un-allocated. In general, the FREESMALL and FREELARGE lists can gradually empty as the SIMT unit works after being initialized. Once the FREESMALL and FREELARGE lists become empty they will not fill up again except on the following events: 1) a SIMT unit is re-initialized; and 2) a SIMT unit finishes executing a thread and the vector registers related to the thread are de-allocated. Under steady state operating conditions all vector register de-allocation is expected to be governed by the eviction processing lists and a replacement algorithm, such as the CLOCK algorithm.

Another list or data structure can be used to implement vector register management by thread. This list or data structure can track virtual vector register “ownership” by thread and can modify vector register swapping and large/small hardware vector register file residence decisions based on whether the thread that owns a particular vector register is suspended or active. For example, if the thread is suspended, all relevant vector register files can be moved to the vector register backing file.

Operationally, if a new virtual vector register file needs to be assigned a physical slot in either the large or small hardware vector register files the EVS2LARGE, EVS2BSTR and EVL2BSTR lists, respectively, are checked. If a pertinent list is not empty, the list's head value is de-queued and the physical vector register associated with the head list element is evicted to the large vector register file or vector register backing store, as appropriate. The newly freed physical vector register is allocated as required. A rule can be implemented that no physical vector register be resident in more than one list (FREE* and EV*) be strictly enforced. In case the appropriate eviction candidate (EV*2*) and free queues are empty and a new physical vector register allocation is needed, the decision of which vector register file to evict from, (either the large or small register file), may be made using a replacement algorithm. In an example replacement algorithm, since vector register file value life time is a strong indicator of eviction suitability, the CLOCK algorithm can be an effective method for determining the vector register file to evict.

Avoidance of potential resource starvation due to dynamic allocation or deadlock can be achieved by ensuring that an active shader in any given compute unit (CU)/SIMT unit be guaranteed to be make progress at any given time. This can be done by designating one active shader as special. This designation gives the designated active shader higher priority than others, (this can be done based on age of dispatch or other meta data), and guarantees all the resources the designated needs even at the expense of inefficiency and starvation for other active shaders.

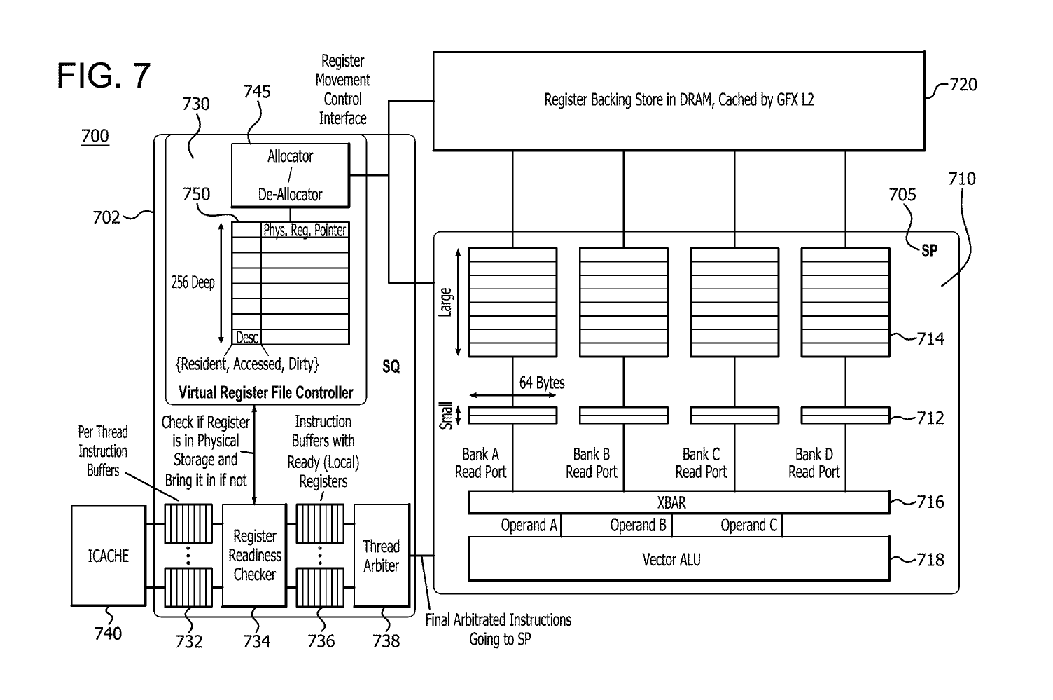

FIG. 7 is a logical block diagram with operational flow for a graphics processor 700 including a virtual vector register file 710. In general, the graphics processor 700 includes two shader pairs (SP), where each SP comprises a pair of SIMT units. Each SIMT unit comprises four VALUs, where each VALU includes four ALUs. For purposes of illustration, FIG. 7 shows a graphics processor 700 with a SP 705 coupled or connected to a sequencer (SQ) 702. The SP 705 includes the virtual vector register file 710, which in turn is comprised of a set of small vector register files 712 coupled to a set of large vector register files 714, respectively. Each of the small vector register files 712 is coupled via read/write ports to a XBAR 716, which in turn is coupled to receive operands from a VALU 718. Each of the large vector register files 714 is coupled to a vector register backing store 720.

The SQ 702 includes a virtual vector register file controller 730, per thread instruction buffers 732, a register readiness checker 734, instruction buffers with ready vector registers 736 and a thread arbiter 738. The per thread instruction buffers 732 are connected to an instruction cache 740. The virtual vector register file controller 730 comprises an allocator/de-allocator module 745 and a register re-mapping table 750.

Operationally, the per thread instruction buffers 732 are fed instructions from the instruction cache 740. Instructions at the head of each per thread instruction buffer 732 are eligible to issue. The vector register readiness checker 734 determines whether the head instructions vector registers are in physical storage “ready to use”, (e.g. the small vector register file 712) or are in the large vector register file 714 or vector register backing store 720. If the vector registers are ready to use, the instruction gets forwarded to the instruction buffers with ready vector registers 736 where it awaits to be chosen to issue via the thread arbiter 738 to the SP 705, (i.e. the VALU 718).

If a vector register happens to not be resident in the hardware vector register file when it is needed by an instruction, the vector register readiness checker 734 would get notified that is the case, and the relevant thread that caused the access would be suspended and another thread would be selected for execution. The virtual vector register file controller 730 then performs a swapping process, (eviction/allocation analysis), to bring the required vector registers in to at least the small vector register file 712. The allocator/de-allocator module 745 and the vector register re-mapping table 750 reviews the eviction and free lists, as appropriate, to determine which already resident vector registers to evict in order to bring in the required ones. The choosing can be done based on standard eviction policies such as least recently used, for example. Subsequently the virtual vector register file controller 730 swaps the missing vector register in and notifies the vector register readiness checker 734, (and ultimately the scheduler in the SQ 702), that the thread that wanted the vector register is ready to be scheduled again. The relevant instruction is then be forwarded to the instruction buffers with ready vector registers 736 and waits to issue.

It can be noted that all vector registers associated with instructions in instruction buffers with ready vector registers 736 are disqualified from being sent to the vector register backing store 720, as allowing that may lead to deadlock.

The virtual file register architecture described herein can be implemented as per-SIMT or per-CU. Given that, the virtual register file controller can be implemented in the SP or the SQ, (as shown in FIG. 7).

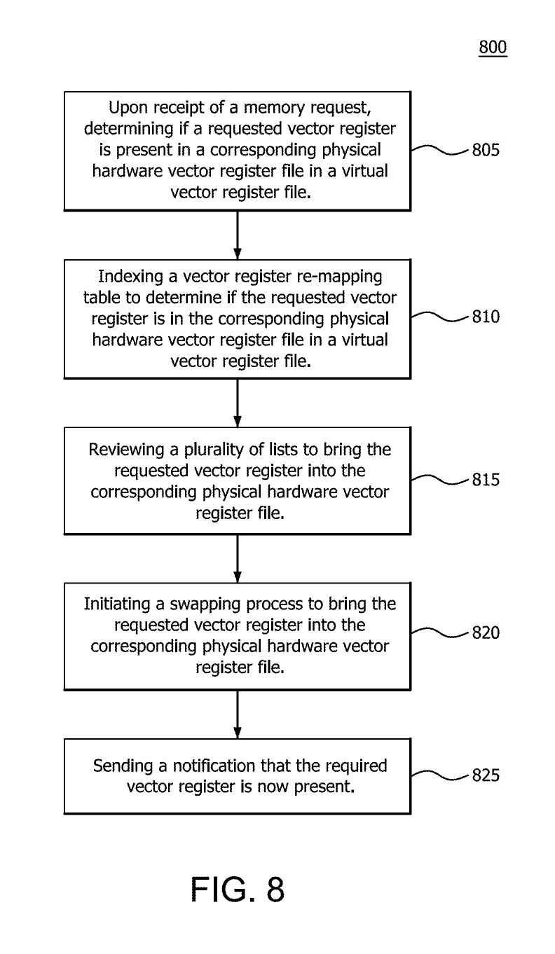

FIG. 8 is a flowchart 800 for using a virtual vector register file in accordance with certain implementations. Upon receipt of a memory request, a graphics processor determines if a requested vector register is present in a corresponding physical hardware vector register file in a virtual vector register file, wherein the virtual vector register file includes a N deep vector register file and a M deep vector register file, N being less than M (block 805). A vector register re-mapping table is indexed to determine if the requested vector register is in the corresponding physical hardware vector register file in a virtual vector register file (block 810). An allocator/de-allocator module reviews a plurality of lists to bring the requested vector register into the corresponding physical hardware vector register file (block 815). A virtual vector register file controller initiates a swapping process to bring the requested vector register into the corresponding physical hardware vector register file (block 820) and sends a notification that the required vector register is now present (block 825).

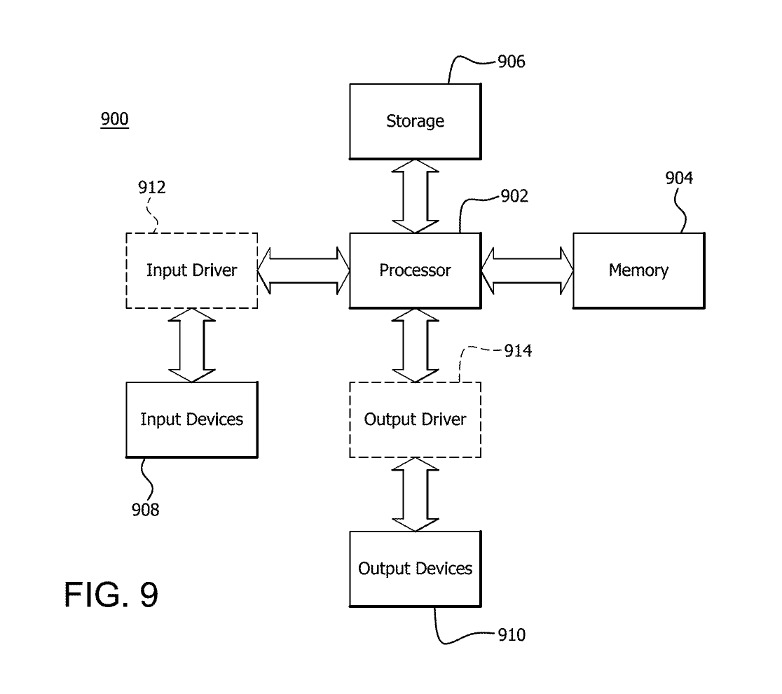

FIG. 9 is a block diagram of an example device 900 in which one or more portions of one or more disclosed embodiments may be implemented. The device 900 may include, for example, a head mounted device, a server, a computer, a gaming device, a handheld device, a set-top box, a television, a mobile phone, or a tablet computer. The device 900 includes a processor 902, a memory 904, a storage 906, one or more input devices 908, and one or more output devices 910. The device 900 may also optionally include an input driver 912 and an output driver 914. It is understood that the device 900 may include additional components not shown in FIG. 9.

The processor 902 may include a central processing unit (CPU), a graphics processing unit (GPU), a CPU and GPU located on the same die, or one or more processor cores, wherein each processor core may be a CPU or a GPU. The memory 904 may be located on the same die as the processor 902, or may be located separately from the processor 902. The memory 904 may include a volatile or non-volatile memory, for example, random access memory (RAM), dynamic RAM, or a cache.

The storage 906 may include a fixed or removable storage, for example, a hard disk drive, a solid state drive, an optical disk, or a flash drive. The input devices 908 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 910 may include a display, a speaker, a printer, a haptic feedback device, one or more lights, an antenna, or a network connection (e.g., a wireless local area network card for transmission and/or reception of wireless IEEE 802 signals).

The input driver 912 communicates with the processor 902 and the input devices 908, and permits the processor 902 to receive input from the input devices 908. The output driver 914 communicates with the processor 902 and the output devices 910, and permits the processor 902 to send output to the output devices 910. It is noted that the input driver 912 and the output driver 914 are optional components, and that the device 900 will operate in the same manner if the input driver 912 and the output driver 914 are not present.

In general, a graphics processor includes a logic unit and a virtual vector register file coupled to the logic unit. The virtual vector register file includes a N deep vector register file and a M deep vector register file, wherein N is less than M. The graphics processor further includes a vector register backing store coupled to the virtual vector register file and a virtual vector register file controller coupled to the virtual vector register file, where eviction/allocation between the N deep vector register file, the M deep vector register file and the vector register backing store is dependent on at least access requests for certain vector registers. The virtual vector register file controller includes a vector register re-mapping table and an allocator/de-allocator module coupled to the vector register re-mapping table and to the virtual vector register file and the vector register backing store.

The vector register re-mapping table is indexed by a virtual vector register number, with each table entry storing a pointer to the vector register backing store or a corresponding physical hardware vector register file in the virtual vector register file. Each table entry includes a resident bit that signifies whether a vector register is physically present in the virtual vector register file, an accessed bit to enable usage of replacement algorithms for vector register allocation/de-allocation, and a dirty bit to optimize write-back to a next higher level of vector register file hierarchy. The allocator/de-allocator uses a plurality of lists to track candidates for eviction and track vector register files that are unallocated for eviction/allocation analysis. The allocator/de-allocator uses a list to track vector register file ownership by thread for eviction/allocation analysis. The virtual vector register file controller presents a logical view to external components that all vector registers are physically implemented in hardware.

In general, a method for using a virtual vector register file in a graphics processor determines if a requested vector register is present in a corresponding physical hardware vector register file in a virtual vector register file, wherein the virtual vector register file includes a N deep vector register file and a M deep vector register file, N being less than M. The method further initiates, by a virtual vector register file controller, a swapping process to bring the requested vector register into the corresponding physical hardware vector register file and sends a notification that the required vector register is now present.

The method further indexes a vector register re-mapping table to determine if the requested vector register is in the corresponding physical hardware vector register file in a virtual vector register file and reviews, by an allocator/de-allocator module, a plurality of lists to bring the requested vector register into the corresponding physical hardware vector register file. The vector register re-mapping table is indexed by a virtual vector register number, with each table entry storing a pointer to the vector register backing store or a corresponding physical hardware vector register file in the virtual vector register file. Each table entry includes a resident bit that signifies whether a vector register is physically present in the virtual vector register file, an accessed bit to enable usage of replacement algorithms for register allocation/de-allocation, and a dirty bit to optimize write-back to a next higher level of vector register file hierarchy. The plurality of lists track candidates for eviction and track vector register files that are unallocated for eviction/allocation analysis. The allocator/de-allocator uses a list to track vector register file ownership by thread for eviction/allocation analysis. The virtual vector register file controller presents a logical view to external components that all vector registers are physically implemented in hardware.

In general, a non-transitory computer readable medium including instructions which when executed in a graphics processor cause the graphics processor to execute a method for using virtual vector register files, the method determining if a requested vector register is present in a corresponding physical hardware vector register file in a virtual vector register file, wherein the virtual vector register file includes a N deep vector register file and a M deep vector register file, N being less than M. The method initiating, by a virtual vector register file controller, a swapping process to bring the requested vector register into the corresponding physical hardware vector register file and sending a notification that the required vector register is now present. The method further indexing a vector register re-mapping table to determine if the requested vector register is in the corresponding physical hardware vector register file in a virtual vector register file and reviewing, by an allocator/de-allocator module, a plurality of lists to bring the requested vector register into the corresponding physical hardware vector register file. The vector register re-mapping table is indexed by a virtual vector register number, with each table entry storing a pointer to the vector register backing store or a corresponding physical hardware vector register file in the virtual vector register file. Each table entry includes a resident bit that signifies whether a vector register is physically present in the virtual vector register file, an accessed bit to enable usage of replacement algorithms for vector register allocation/de-allocation, and a dirty bit to optimize write-back to a next higher level of vector register file hierarchy. The plurality of lists track candidates for eviction and track vector register files that are unallocated for eviction/allocation analysis. The allocator/de-allocator uses a list to track vector register file ownership by thread for eviction/allocation analysis. The virtual vector register file controller presents a logical view to external components that all vector registers are physically implemented in hardware.

In general and without limiting embodiments described herein, a computer readable non-transitory medium including instructions which when executed in a processing system cause the processing system to execute a method for using a virtual vector register file.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A graphics processor, comprising:
a logic unit;
a virtual vector register file coupled to the logic unit, the virtual vector register file including a N deep vector register file and a M deep vector register file, wherein N is less than M;
a vector register backing store coupled to the virtual vector register file; and
a virtual vector register file controller coupled to the virtual vector register file, wherein eviction/allocation between the N deep vector register file, the M deep vector register file and the vector register backing store is dependent on at least access requests for certain vector registers.

2. The graphics processor of claim 1, wherein the virtual vector register file controller includes:
a vector register re-mapping table; and
an allocator/de-allocator module coupled to the vector register re-mapping table and to the virtual vector register file and the vector register backing store.

3. The graphics processor of claim 2, wherein the vector register re-mapping table is indexed by a virtual vector register number, with each table entry storing a pointer to the vector register backing store or a corresponding physical hardware vector register file in the virtual vector register file.

4. The graphics processor of claim 3, wherein each table entry includes a resident bit that signifies whether a vector register is physically present in the virtual vector register file, an accessed bit to enable usage of replacement algorithms for vector register allocation/de-allocation, and a dirty bit to optimize write-back to a next higher level of vector register file hierarchy.

6. The graphics processor of claim 2, wherein the allocator/de-allocator uses a plurality of lists to track candidates for eviction and track vector register files that are unallocated for eviction/allocation analysis.

7. The graphics processor of claim 7, wherein the allocator/de-allocator uses a list to track vector register file ownership by thread for eviction/allocation analysis.

8. The graphics processor of claim 1, wherein the virtual vector register file controller presents a logical view to external components that all vector registers are physically implemented in hardware.

9. A method for using a virtual vector register file in a graphics processor, the method comprising:
determining if a requested vector register is present in a corresponding physical hardware vector register file in a virtual vector register file, wherein the virtual vector register file includes a N deep vector register file and a M deep vector register file, N being less than M;
initiating, by a virtual vector register file controller, a swapping process to bring the requested vector register into the corresponding physical hardware vector register file; and
sending a notification that the required vector register is now present.

10. The method for using a virtual vector register file in a graphics processor of claim 9, further comprising:
indexing a vector register re-mapping table to determine if the requested vector register is in the corresponding physical hardware vector register file in a virtual vector register file;
reviewing, by an allocator/de-allocator module, a plurality of lists to bring the requested vector register into the corresponding physical hardware vector register file.

11. The method for using a virtual vector register file in a graphics processor of claim 10, wherein the vector register re-mapping table is indexed by a virtual vector register number, with each table entry storing a pointer to the vector register backing store or a corresponding physical hardware vector register file in the virtual vector register file.

12. The method for using a virtual vector register file in a graphics processor of claim 11, wherein each table entry includes a resident bit that signifies whether a vector register is physically present in the virtual vector register file, an accessed bit to enable usage of replacement algorithms for register allocation/de-allocation, and a dirty bit to optimize write-back to a next higher level of vector register file hierarchy.

13. The method for using a virtual vector register file in a graphics processor of claim 10, wherein the plurality of lists track candidates for eviction and track vector register files that are unallocated for eviction/allocation analysis.

14. The method for using a virtual vector register file in a graphics processor of claim 10, wherein the allocator/de-allocator uses a list to track vector register file ownership by thread for eviction/allocation analysis.

15. The method for using a virtual vector register file in a graphics processor of claim 9, wherein the virtual vector register file controller presents a logical view to external components that all vector registers are physically implemented in hardware.

16. A non-transitory computer readable medium including instructions which when executed in a graphics processor cause the graphics processor to execute a method for using virtual vector register files, the method comprising the steps of:
determining if a requested vector register is present in a corresponding physical hardware vector register file in a virtual vector register file, wherein the virtual vector register file includes a N deep vector register file and a M deep vector register file, N being less than M;
initiating, by a virtual vector register file controller, a swapping process to bring the requested vector register into the corresponding physical hardware vector register file; and
sending a notification that the required vector register is now present.

17. The non-transitory computer readable medium of claim 16, further comprising:
indexing a vector register re-mapping table to determine if the requested vector register is in the corresponding physical hardware vector register file in a virtual vector register file;
reviewing, by an allocator/de-allocator module, a plurality of lists to bring the requested vector register into the corresponding physical hardware vector register file.

18. The non-transitory computer readable medium of claim 17, wherein the vector register re-mapping table is indexed by a virtual vector register number, with each table entry storing a pointer to the vector register backing store or a corresponding physical hardware vector register file in the virtual vector register file.

19. The non-transitory computer readable medium of claim 18, wherein each table entry includes a resident bit that signifies whether a vector register is physically present in the virtual vector register file, an accessed bit to enable usage of replacement algorithms for vector register allocation/de-allocation, and a dirty bit to optimize write-back to a next higher level of vector register file hierarchy.

20. The non-transitory computer readable medium of claim 17, wherein the plurality of lists track candidates for eviction and track vector register files that are unallocated for eviction/allocation analysis.

21. The non-transitory computer readable medium of claim 17, wherein the allocator/de-allocator uses a list to track vector register file ownership by thread for eviction/allocation analysis.

22. The non-transitory computer readable medium of claim 16, wherein the virtual vector register file controller presents a logical view to external components that all vector registers are physically implemented in hardware.
